(19) United States
(12) Patent Application Publication
(10) Pub. No.: US 2023/0236640 A1
(43) Pub. Date: Jul. 27, 2023

(54) SYSTEM FOR PACKAGING A PORTABLE COMPUTER

(71) Applicant: Michael Feroli, New York, NY (US)

(72) Inventor: Michael Feroli, New York, NY (US)

(21) Appl. No.: 18/128,206

(22) Filed: Mar. 29, 2023

Related U.S. Application Data
(63) Continuation-in-part of application No. 17/308,584, filed on May 5, 2021.

(51) Int. Cl. G06F 1/16

(52) U.S. Cl. CPC G06F 1/1679; G06F 1/1607; G06F 1/1647; G06F 1/1669

(57) ABSTRACT

A portable computer system comprising at least two flat screen displays that is configurable so that in a stowed state, the system is conveniently carried and the flat screens are protected.

### PRIORITY CLAIM

This is a utility patent application that claims priority as a Continuation in Part to U.S. patent application Ser. No. 17/308,584 filed on 5 May 2021, which is incorporated by reference for all that it teaches.

### FIELD OF INVENTION AND BACKGROUND

This invention relates to a method for packaging the components of a computer system in order to make the system portable.

### SUMMARY

The rise of the remote work model has increased the use of portable computers and workstations. Many workplaces and employees utilize more than one monitor at their workstation. In the past, when electronics were still heavy and bulky, the notion was to create modular components that would be slid in and out so that when travelling, the portable device had the minimum components, but at some home base, would integrate into other components to create a desktop capability. The prior art discloses is a keyboard that fits into a panel that forms a brief case, but not a panel that is a component of a display screen module. The prior art discloses forming a portable computer out of pluggable modules for ease of transport. But that is for leaving components behind when travelling. The older prior art discloses folding a portable computer into a case structure, but not using two screens, integrating the screens themselves into a carrying case that is separable into the different components. Therefore, there is a need for a computer packaging system that is comprised of two screens that are configurable as a carrying case and separable into two deployed viewing screens with additional interactive input devices, like a keyboard or mouse.

### DESCRIPTION OF THE FIGURES

The headings provided herein are for convenience only and do not necessarily affect the scope or meaning of the claimed invention. In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced (e.g., element 101 is first introduced and discussed with respect to FIG. 1).

FIG. 1: Exemplary view of the invention in its deployed state

FIG. 2: Exemplary view of the invention being placed into its stowed state

FIG. 3: Exemplary side view of the invention being placed into its stowed state

FIG. 4: Exemplary view of the invention in its deployed state

FIG. 5: Exemplary view of the keyboard of the invention and one stand being placed into its stowed state

FIG. 6: Exemplary view of the invention being placed into its stowed state using a latching mechanism

FIG. 7: Exemplary close up side views of the invention with the latching mechanism

FIG. 8: Exemplary side view of the invention showing latches and spacing mechanism

FIG. 9: Exemplary view of the invention in its closed state with handles deployed

FIG. 10: Exemplary view of the invention being placed into its stowed state using a trough at the bottom and a tongue and groove mechanism at the top.

FIG. 11: Exemplary view of the invention being placed into its stowed state using a tongue and groove mechanism at the bottom and latching mechanism at the top.

FIG. 12: Exemplary view of the invention with an interlocking edge on a first display component into which an interlocking edge on a second display component may be seated.

FIG. 13: Exemplary view of the invention with a protruding lip edge on a first display component housing into which an opposing edge on a second display component may be seated.

FIG. 14. Exemplary cross sectional view of the invention with a magnetized groove and slot along the edge of the first and second housing chassis, respectively, in the stowed state.

FIG. 15. Exemplary close up cross sectional view of the invention with a magnetized groove and slot along the edge of the chassis for the first display component housing and second display component housing, respectively, in a detached state as it moves into the deployed state.

FIG. 16. Exemplary close up cross sectional view of the invention with a groove and slot along the edge of the chassis for the first display component housing and second display component housing, respectively, in a stowed state.

FIG. 17 Exemplary cross sectional view of the invention with a groove and slot along two of the edges of the chassis for the first display component housing and second display component housing, respectively, in a stowed state.

### DETAILED DESCRIPTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other features not described in detail herein. Additionally, some well-known structures or functions may not be shown or described in detail below, so as to avoid unnecessarily obscuring the relevant description. The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

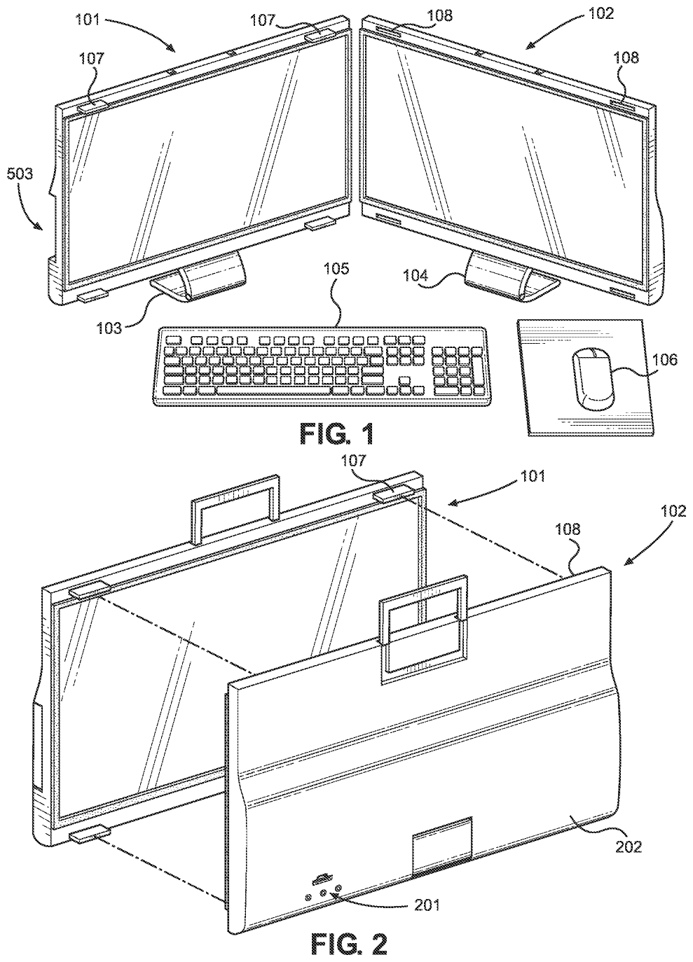

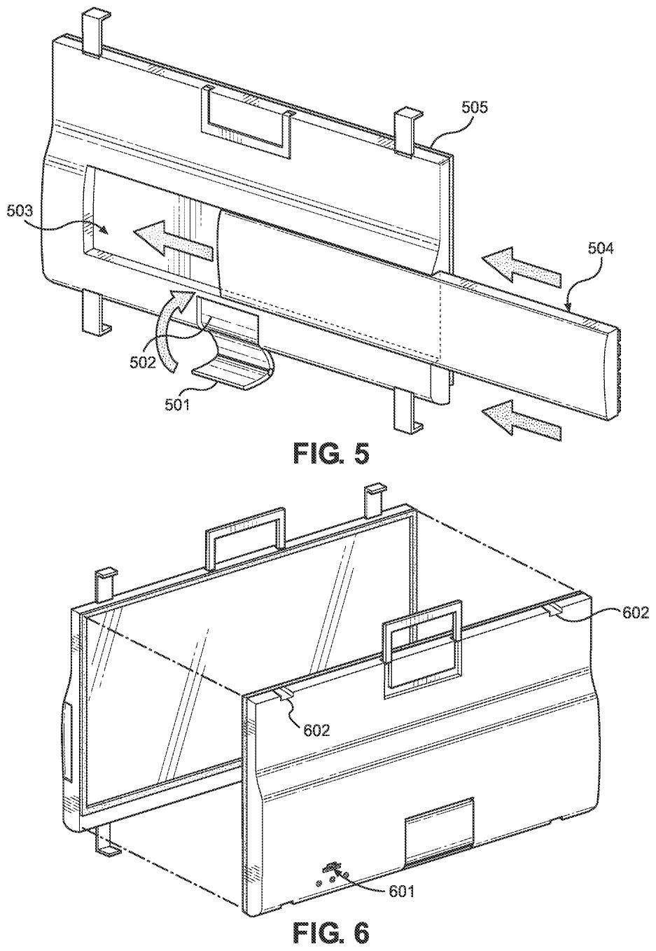

The invention is comprised of two computer display screen components, (101, 102) which may be comprised of LCD flat screens (or similar technology) with foldable stands (103, 104) affixed thereto. The first of the screen components has a computer module within it that is in communication with a keyboard (105) or other input device component, a mouse (106) or other pointing input device component, and also in communication with the second display screen component. The computer module may be comprised of a microprocessor, a local random access data memory device, a mass data storage device, an input and output interface device and a communication portal device. The computer module may be comprised of a printed circuit card that is mounted within the housing of either the first or the second display component. The invention is configured to be usable in two states. In a preferred embodiment, the invention is comprised of two flat display screens that, in a first state have two separate stands that preferably unfold from the housing of the display screen components in order that the two display screens stand upright on a flat surface (FIG. 1). In this embodiment, the two stands are shaped along the bottom portion so that a first end of the stand is connected to the bottom of the display component housing and the second end of the stand is a part of the stand that sits on a surface, for example, a desk or table and the part is shaped such that the point of projection of the center of gravity of the display component onto the surface is substantially equidistant between a first and second support points comprising the stand part that is proximate or touching the surface. Each stand may be hinged on the first end (502) so that it can fold up into its respective housing, in a recessed area (501) and when deployed, locked into place in order to maintain a fixed vertical position for its respective display screen. (FIG. 5).

The communication between the system components may be accomplished by wires, for example, USB cables that run between the first display screen component housing and the other components. In this configuration, the first display component (102) is comprised of a computer module housed within the display component housing (202) that can transmit data to the second display screen (101) for display on that screen. Further, the keyboard component (105) and mouse component (106) can transmit cursor position data, keying data and relative motion or scrolling data into the computer for use by computer programs being executed by the computer. Alternatively, each component may be comprised of a wireless bi-directional communication circuit, for example, a Bluetooth circuit. The keyboard and mouse input components may be comprised of a battery holder and power circuitry so that in use, a battery may be inserted into the component that powers the component. The data communications between the components may be accomplished using a communication protocol between the components. The first display unit comprised of a computer may also be comprised of a power input connection (201) that is part of a circuit to deliver power to the computer as well as the display and a wired data network connection, in one embodiment, an Ethernet™ jack. (601). The second display component may also be comprised of a power connection and further be comprised of a circuit that delivers power to the flat panel display.

In the second, stowed state, the two screens face each other (FIG. 2) and are attached at least one point along the four edges comprising their respective display components. The first and second display components are comprised of at least one attachment mechanism that in the stowed state secures one screen (101) to the other (102). The attachment points may be comprised of mechanical attachment points proximate to the four corners of the display screens. The attachment mechanism may be comprised of a member that runs along an entire edge of the display components. In one embodiment, a first of the two display components is comprised of a tongue (107) protruding from the surface of its housing, while the second of the two display components is comprised of a slot (108) in the surface of its housing that is positioned such that the tongue enters the slot when the two display components are mated together. (FIG. 2). The tongue and slot mechanism is preferably comprised of a configurable locking mechanism that in the stowed state prevents the tongue from sliding out of the slot, and then selectably permits the tongue to slide out of the slot when the invention is being transformed into the deployed state. In one embodiment, the tongue may have a hole from one side of the tongue to the other, such that the axis of the hole is substantially to the plane of the screen and a mechanism embedded in the display comprised of the slot, where the mechanism is comprised of a cylindrical member that is slides into the hole in order to secure the position of the tongue, and slide back out in order to release the tongue.

In the stowed state, the attached display components (101, 102) have the overall appearance of a case that protects both screens comprising the first and second display components. FIG. 9. In this embodiment, the back of one or both of the display component housing includes a foldable and hinged member that when deployed meets the other member so as to form a carrying handle. (901). Further, the second display component housing (101) may have a recessed section (503) on the surface of the housing opposite to the surface of the flat screen display, the recessed section sized to receive the keyboard component (504) in its stowed state. FIG. 5. The keyboard mounting is secured by a sufficiently secure latching mechanism. Similarly, a locking mechanism comprises the display component in which the keyboard is stowed. (503) As a result, when deployed, a button or other mechanical actuator may be used to release the locking mechanism and permitting the keyboard to be slid out. (504). The deployment of the keyboard is accomplished by pressing the “unlock” button, and then removing the keyboard stored in the first display component housing.

In another embodiment, the first and second display components may be held together in the stowed state by at least one hinged locking flaps. FIG. 4 (401, 402, 403, 404). On one of the display components, the locking flap is attached with a hinge at one end (505) that moveably attaches it to the display component. When the invention is placed in the stowed state, the locking flap is pivoted using the hinge (801) so that the opposite end of the flap (802) comes onto and around the edge of the other display component (902, 903). In a preferred embodiment (FIG. 6), the other display component has recessed vias (602) into which the flap end maybe received so as to be flush with the surface of the display screen in the stowed state. (902, 903), In a preferred embodiment, the locking end of the lockable flap can engage a mechanism comprising the other display component that mechanically holds the locking flap into place until such time it is mechanically released when the system is deployed. FIG. 8. In a preferred embodiment, the second end of the locking flap extends into a locking mechanism comprising the second display component housing. In this embodiment, the hinged members are secured in a manner by a latching mechanism so that the screens do not separate unless an “unlock” button is pressed, which permits the locking mechanism to be released and thereby the first and second display components to be separated.

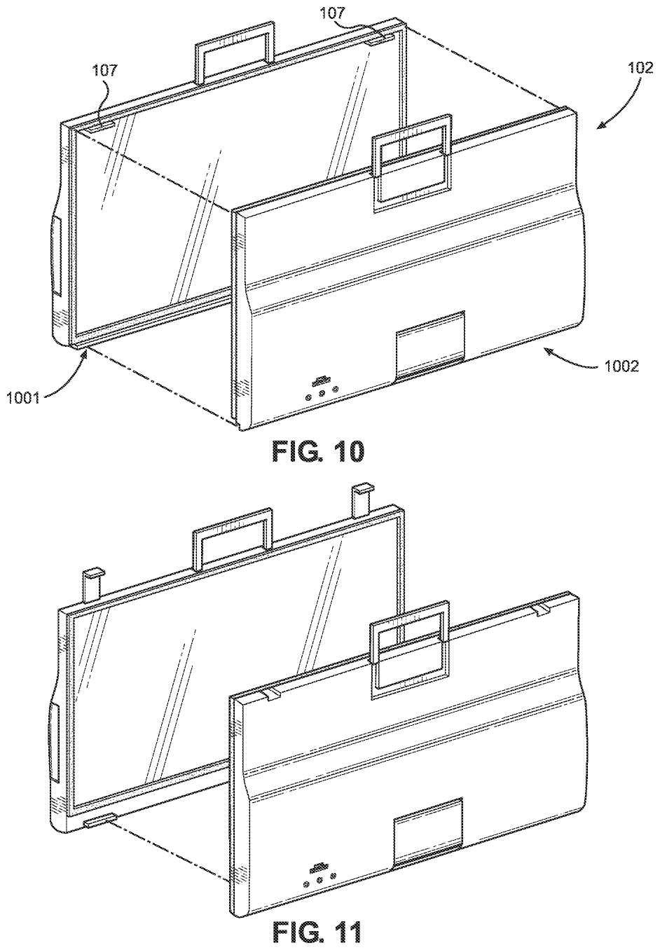

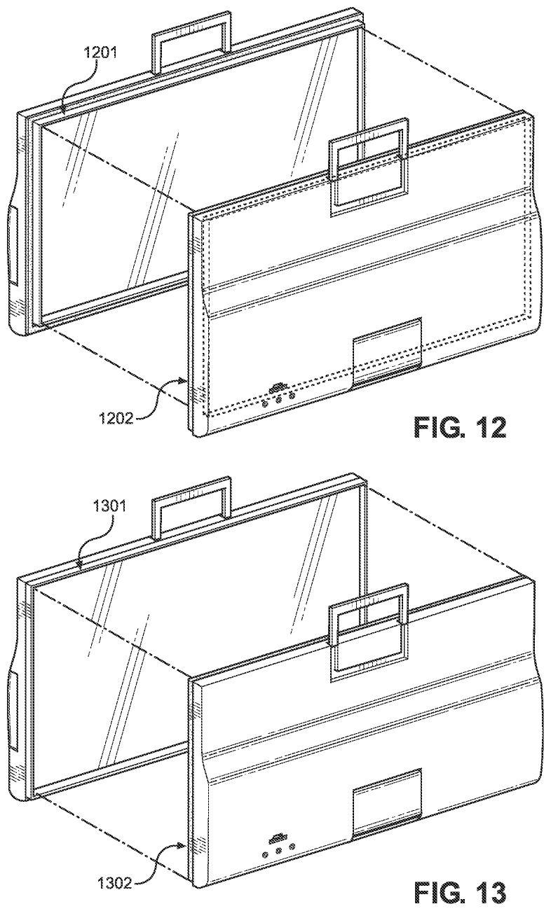

In yet another embodiment (FIG. 10), when in the stowed state, the two display components may be coupled to each other using a grooved shelf comprising a first of the display components (1001) onto which the bottom edge of a second display (1002) component rests and upon which the second display component pivots so that the tongue (107) is inserted into the slot of the opposite display (108) to close and secure the system. In an alternative embodiment (FIG. 11), the two lower connection may use a tongue and slot combination and the top two connections use the hinged locking flap. In this embodiment, the tongue and slot mechanism may permit some amount of hinging in order to ease the alignment of the locking mechanisms.

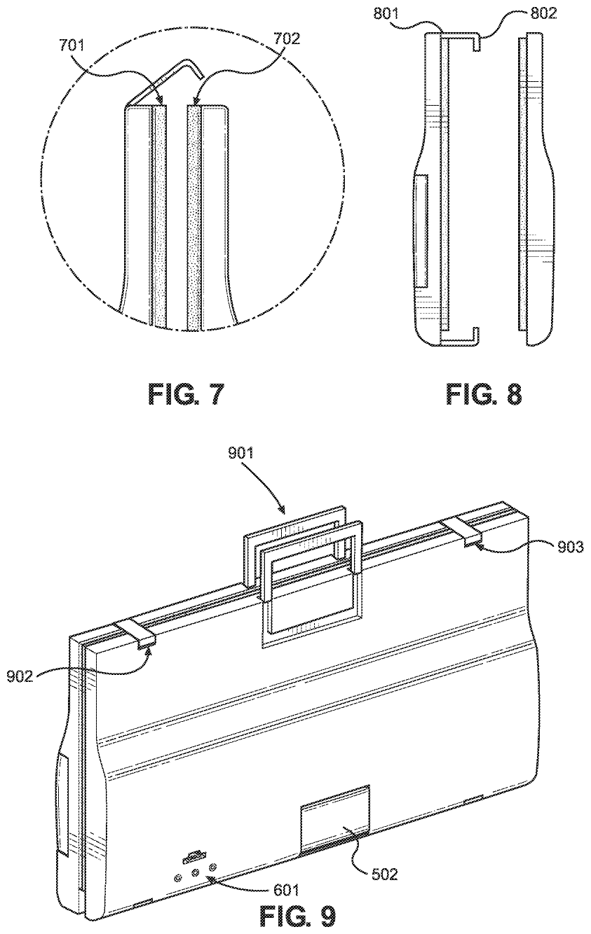

In a preferred embodiment, the first and second display components, when mated in the stowed state, do not shove the two surfaces of their respective display flat screens against each other, or otherwise permit substantial touching and rubbing between the surfaces of the flat screens. To prevent this condition, a spacing mechanism is utilized that maintains a separation or otherwise minimizes the stress between the two display flat screen surfaces in the stowed state. In one embodiment (FIG. 7), a bumper or spacer strip may be present on one or both of the display components, (701, 702) on the same side as the display flat screens. The bumper may be of a flexible or resilient material, for example, a plastic or rubber foam. In one embodiment, one of the display components may have the bumper layer, and the other no bumper layer, or both components have a bumper layer that matches up to each other.

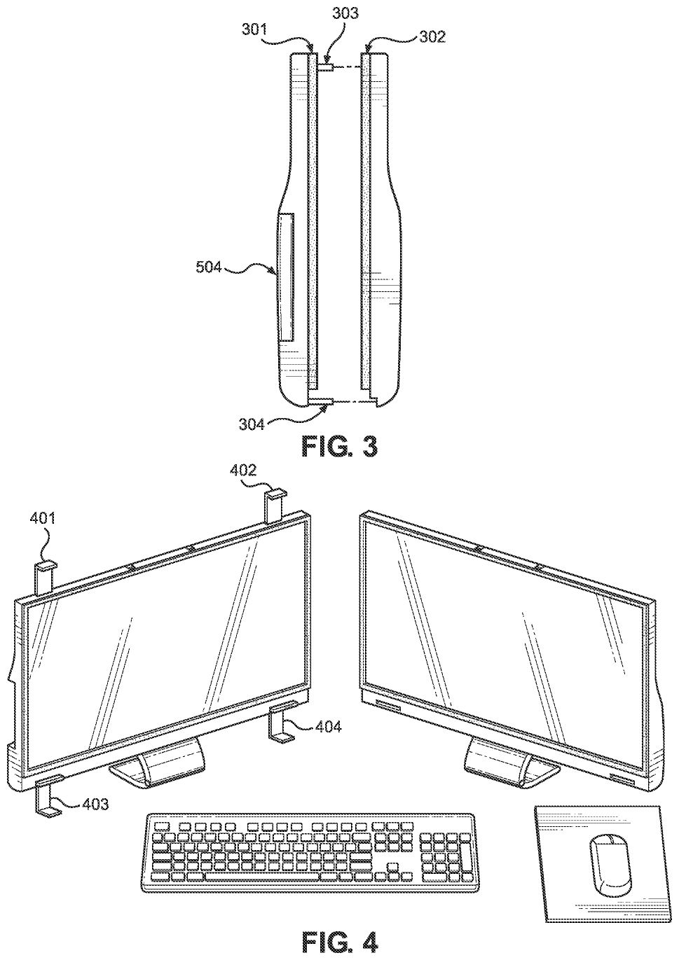

In another embodiment, the locking mechanism performs the function of the spacing mechanism. In one embodiment, the tongue and slot mechanism may be used to keep the display flat screens surfaces separated when the system is in the stowed state. FIG. 3. In this embodiment, the tongue (303, 304) is of sufficient length to slide into the slot on the opposite display component housing and lock into place while the first screen surface (301) does not touch the second screen surface (302), locked so as to inhibit motion of the tongue further in or out of the slot. In yet another embodiment, the system may utilize the locking flaps to hold the first and second display components together, but use a tongue or other stand-off mounted preferably at the corners of the one of the display screens to hold the two screens away from each other by a predetermined distance when the locking flaps are locked into place in the stowed state.

In embodiments where the locking mechanism performs the function of the spacing mechanism, there is a fender that surrounds the four edges of the mated display components. The fender blocks dust and moisture from entering the space between the two flat screens. In this embodiment, the fender may be comprised of flexible material, like rubber or plastic foam that forms a perimeter around the flat screens that comprise the first and second display components. In one embodiment, the attachment locking mechanism is within the perimeter of the fender. In another embodiment, the locking mechanism is outside that perimeter. In yet another embodiment, the first display component housing is comprised of a shape that forms a first interlocking edge (1201) that protrudes along all four edges of the housing perpendicular to the plane of the first flat screen, and the second display component housing is comprised of a shape that forms a second interlocking edge (1202) that protrudes along all four edges of the housing perpendicular to the plane of the second flat screen such that when the system is in the stowed state, the first interlocking edge mates with the second interlocking edge. This can both maintain separation between the flat screen surfaces and prevent dust or moisture entering the space between them. In one embodiment, the housing of a first of the display components can be shaped to form an interlocking lip (1301) that protrudes along all four edges of the housing perpendicular to the plane of the flat screen comprising the first display component, and configured so that in the stowed state, the four outer edges of a second of the two display components (1302) slides into place within interior side of the four edges of protruding lip that is proud of the first display component surface. In this embodiment, the protruding lip along the bottom of the first display component may further function as the groove shelf described above.

In yet another embodiment, the first or second display component housing may be shaped to hold one or two compartments configured to stow the mouse (106) or any cabling.

In yet another embodiment, the first and second display components (1401, 1402) may utilize magnets embedded in the respective first and second display component chassis in order to attach to each other in the stowed state. (1403, 1404). In this embodiment, two magnets (1501, 1502) arranged to be attracted to each other are embedded along the respective edges of the first and second display components where the edges match when in the stowed state (1503, 1504). Additionally, the first and second flat screen surfaces (1601. 1602) are arranged within the respective first and second display components such that when the two magnets hold the first and second display components together, the first and second flat screen surfaces do not touch each other. (1505, 1506)

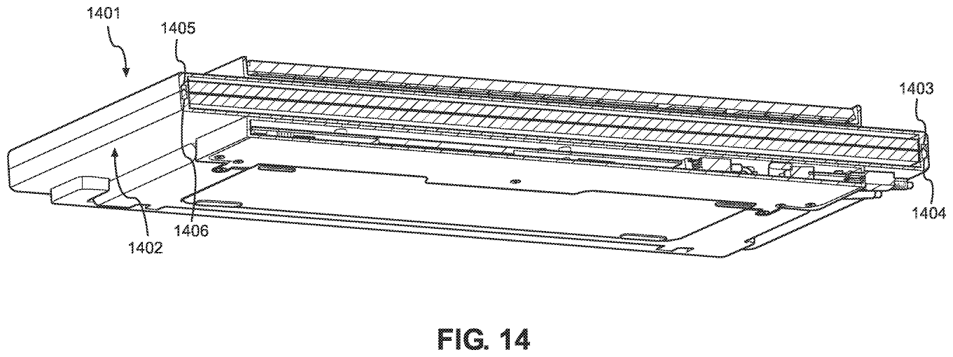

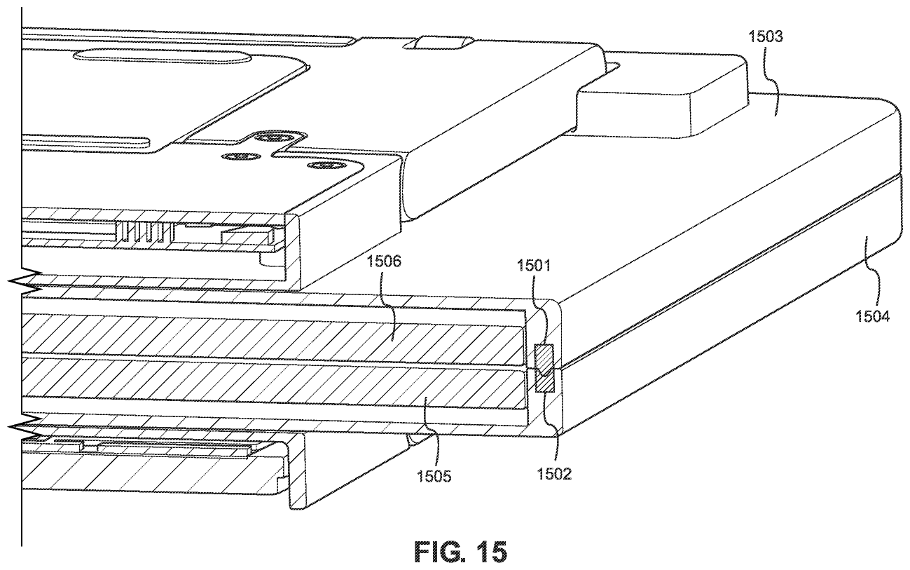

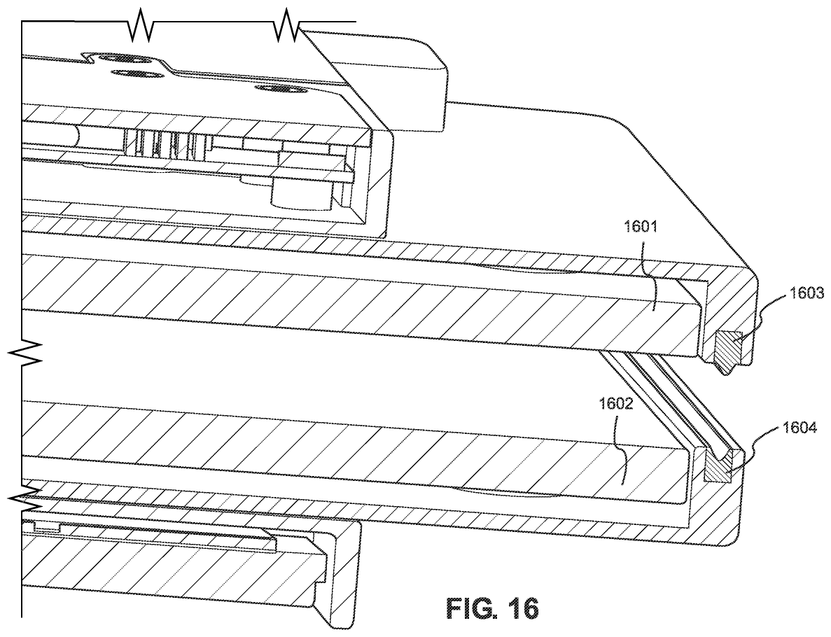

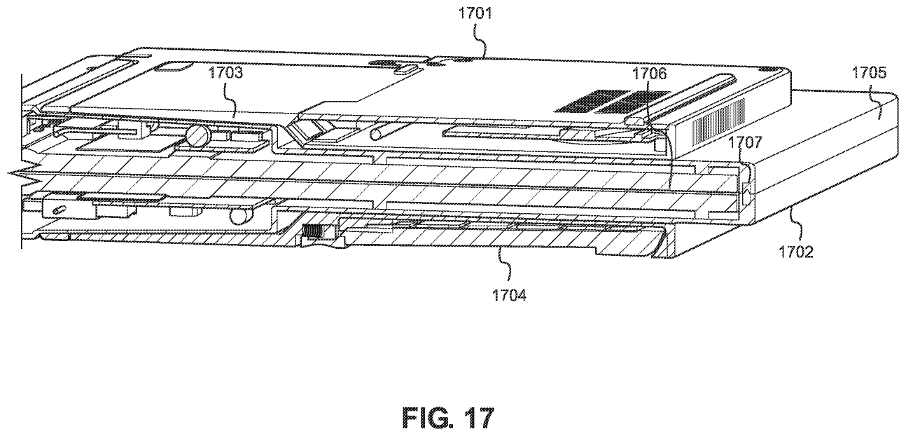

In preferred embodiment, the magnets (1603. 1604) may be shaped so that one is in the form of a groove (1604) while the other is in the form of a tongue (1603). When placed in the stowed state, the tongue and groove keep the first and second display components from shifting position. (1501, 1502) Further, at least two of the edges of the first and second display components may house the mating magnetic attachments. FIG. 14. When transformed into the deployed state, the first and second display components (1401, 1402) are pulled apart with a force that exceeds the attractive force of the magnets (1403, 1404, 1405, 1406).

In this embodiment, there is at least one mating mechanism comprised of a first shape that forms a first interlocking edge comprised of a first magnetic attachment mechanism that protrudes substantially along at least one edge of the first housing perpendicular to the plane of the first flat screen, and the second housing is comprised of a second shape that forms a second interlocking edge comprised of a second magnetic attachment mechanism that protrudes substantially along at least one edge of the second housing perpendicular to the plane of the second flat screen such that when the system is in the stowed state, the first magnetic attachment is attracted to the second magnetic attachment mechanism with sufficient force to hold the first interlocking edge into the second interlocking edge, with an orientation where the first side faces the third side, said first housing and second housing configured to hold the first screen away from the second screen by a predetermined distance in the stowed state and where said first and second magnetic attachment mechanisms are configured to release the first housing from the second housing in a deployed state where a separating force of a predetermined magnitude is applied to the first and second housings, said separating force being normal to the plane of the first and second display screens when they are in the stowed state. Additionally, in this embodiment, there may be one or more depressed regions along an edge of the first or second housing, or both that permits a user to insert their fingertips so as to engage the separating force that separates the first housing from the second housing in order to place the system into its deployed state.

In the preferred embodiment, the first housing (1701) contains the computer electronics (1703) and in the stowed state, the second housing contains the keyboard (1704). The first and second edges of the housings are flush in the stowed state (1705) while the magnetic attachment (1707) holds them together with a magnetic force. In the stowed state, the two display screens face each other with sufficient separation (1706) such that any compression of the first housing with respect to the second housing, in a direction normal to the plane of the housing does not cause undue stress on the surface of the display screens that would damage either screen. being pressed into the second housing,

The foregoing description discloses only exemplary embodiments of the invention. Modifications of the above disclosed apparatus and methods which fall within the scope of the invention will be readily apparent to those of ordinary skill in the art. Accordingly, while the present invention has been disclosed in connection with exemplary embodiments thereof, it should be understood that other embodiments may fall within the spirit and scope of the invention as defined by the following claims.

What is claimed:

1. A computer system comprised of:
a first housing comprised of a first side and a second side, the first side comprised of a first flat screen, and the first housing further comprised of a first articulated stand component adjustably attached to the first housing;
a second housing comprised of a third side and a fourth side, the third side comprised of a second flat screen and the second housing further comprised of a second articulated stand component adjustably attached to the second display component;
at least one mating mechanism comprised of
a first magnetic attachment mechanism comprising an edge of the first housing a second magnetic attachment mechanism comprising an edge of the second housing such that when the system is in the stowed state, the first magnetic attachment is attracted to the second magnetic attachment mechanism with sufficient force to hold the first magnetic attachment mechanism into the second magnetic attachment mechanism,
wherein said first housing and second housing in the stowed state has an orientation where the first side faces the third side, said first housing and second housing configured to hold the first screen away from the second screen by a predetermined distance in the stowed state and where said first and second magnetic attachment mechanisms are configured to release the first housing from the second housing into a deployed state when a separating force of a predetermined magnitude is applied to the first and second housings perpendicular to their respective sides;
a computer module comprising either the first housing or the second housing;
where in the deployed state, the first housing and second housing are configurable to be independently supported by the respective first and second articulated stand components.

2. The computer system of claim 1 where the articulated first stand component and the second articulated stand component that in the deployed state supports the respective first flat screen and second flat screen in a substantially vertical position and in the stowed state fold against a corresponding first and second corresponding areas of the corresponding first and second housing.

3. The computer system of claim 1 where the corresponding first or second housing is further comprised of a depressed region of a predetermined length along one edge that is usable to engage the separating force of the first housing away from the second housing.

4. The system of claim 1 where the first magnetic attachment mechanism is comprised of a tongue member that protrudes from the edge of the first housing and is positioned such that the tongue member enters a slot comprising the second magnetic attachment mechanism when the first housing and second housing are mated together to place the system in the stowed state.

5. The system of claim 1 further comprising an attachment mechanism comprised of a tongue and a slot that in the stowed state prevents the tongue from sliding out of the slot, and then selectably permits the tongue to slide out of the slot when the system is being transformed into the deployed state.

6. The system of claim 1 further comprising an attachment mechanism that is comprised of at least one locking flap, said locking flap comprised of a first end that is attached to the first housing by a movable hinge and a second end that when the system is placed in the stowed state, the second end of the locking flap extends into a locking mechanism comprising the second housing.

7. The system of claim 1 where the mating mechanism is comprised of a grooved shelf comprising an at least one first edge of the first housing that when the system is placed in the stowed state, receives a second edge portion of the second housing.

8. The system of claim 1 at least one attachment mechanisms situated at a corresponding at least one corner of the first and second housings proximate to an at least one corresponding corners of the first and second display screens. pair.

9. The system of claim 8 where the attachment mechanism is comprised of at least one locking flap that comprises an edge opposite the first edge that further comprises either the first or second housings.

10. The system of claim 1 where the mating mechanism is comprised of a first tongue and groove and a second tongue and groove situated proximate to a corresponding first and second corners sharing a first edge of the corresponding first and second housings.

11. The system of claim 1 further comprising a spacing mechanism that in the stowed state maintains a predetermined separation distance or otherwise minimizes a stress between a first surface comprising the first flat screen and a second surface comprising the second flat screen.

12. The system of claim 11 where the spacing mechanism is a spacer strip that extends substantially along at least one edge of at least the first flat screen or the second flat screen.

13. The system of claim 12 where the spacer strip is comprised of a resilient material.

14. The system of claim 11 where the spacing mechanism is comprised of the mating mechanism.

15. The system of claim 14 where the spacing mechanism is comprised of a tongue member adapted to protrude from the first housing and is positioned such that the tongue member enters a groove that comprises the second housing when the first housing and second housing are mated together to place the system in the stowed state and the tongue member is of sufficient length to slide into the groove on the second housing and lock into place while the first screen surface does not touch the second screen surface, and is locked so as to inhibit motion of the tongue further in or out of the groove.

16. The system of claim 1 further comprising a bumper that substantially surrounds the four edges of the first and second display components in the stowed state, said bumper configured to substantially block dust or moisture from entering the space between the first and second flat screens when the system is in the stowed state.

17. The system of claim 11 where the spacer mechanism is at least one stand-off mounted proximate to at least one corner of the first housing or second housing, said stand off protruding from the surface of the respective first housing or second housing to hold the first screen surface and second screen surface away from each other by the predetermined separation distance when the system is in the stowed state.

18. The system of claim 1 where the first housing is shaped to form a protruding lip that protrudes along all four edges of the first display component housing, perpendicular to the plane of the flat screen comprising the first display component, and configured so that in the stowed state, the four outer edges of the second housing slides into place within an interior of the four edges of the protruding lip that is proud of a first display component surface.

19. The system of claim 1 further comprising a keyboard module that is comprised of a keyboard attachment mechanism that selectably attaches the keyboard module to the first housing or the second housing in the stored state and is detachable from the corresponding first housing or second housing when in the deployed state.
